(19) United States
(12) Patent Application Publication
(10) Pub. No.: US 2015/0268737 A1
(43) Pub. Date: Sep. 24, 2015

(54) GESTURE-BASED CONTROLLER FOR USE IN AXISYMMETRIC HOUSING

(71) Applicant: Bose Corporation, Framingham, MA (US)

(72) Inventors: Neil Gelfond, Shrewsbury, MA (US); Darius Darayes Mobed, Watertown, MA (US); Andrew Olcott, Newtonville, MA (US)

(73) Assignee: Bose Corporation, Framingham, MA (US)

(21) Appl. No.: 14/665,531

(22) Filed: Mar. 23, 2015

Related U.S. Application Data
(60) Provisional application No. 61/968,652, filed on Mar. 21, 2014.

(51) Int. Cl. G06F 3/01

(52) U.S. Cl. CPC G06F 3/017

(57) ABSTRACT

A gesture-based remote for controlling a controlled device has a first axis that defines a transverse plane normal to the first axis, an acceleration sensing system configured to detect a direction of acceleration of the remote in the transverse plane, a controller, wherein the controller is configured to receive data from the acceleration sensing system and to, based at least in part on the data, estimate an intended direction of a gesture, and a transmission system for receiving data representative of the estimate from the controller and transmitting a direction signal to the device to be controlled, the direction signal being indicative of the intended direction. The direction signal is independent of rotation of the remote about the first axis.

### RELATED APPLICATION

This application claims benefit from U.S. Provisional Patent Application No. 61/968,652, filed Mar. 21, 2014 and titled “GESTURE-BASED CONTROLLER FOR USE IN AXISYMMETRIC HOUSING,” the entire contents of which are incorporated herein by reference.

### TECHNICAL FIELD

This disclosure pertains to remote controllers, and in particular, to remote controllers in which a particular gesture is intended to communicate an instruction to a controlled device.

### BACKGROUND

Gesture-based remote controllers have become widespread in gaming. Such controllers communicate a holder's gestures to a controlled device, thus enabling the holder to simulate such games as tennis, baseball, and the like.

Known controllers have a generally linear housing having an active end. To use the controller, the holder must point the active end of the controller at the controlled device. In effect, this aligns the controller's local coordinate system with a stationary coordinate system of the controlled device. With the coordinate systems thus aligned, an accelerometer in the controller can transmit information representing gestures to the controlled device using the stationary coordinate system.

A disadvantage of known controllers is that their form is in large part dictated by their function. Because they must be aligned to conform to a stationary coordinate system, the overall form of the controller must communicate to the holder the proper way to align the controller before use.

### SUMMARY

A gesture-based controller that does not have to be pointed at a controlled device to be operated correctly is described herein. The gesture-based controller of the can thus be housed in an axisymmetric housing.

In one aspect, an apparatus includes a gesture-based remote for controlling a controlled device. Such a remote has a first axis that defines a transverse plane normal to the first axis, an acceleration sensing system configured to detect a direction of acceleration of the remote in the transverse plane, a controller, wherein the controller is configured to receive data from the acceleration sensing system and to, based at least in part on the data, estimate an intended direction of a gesture, and a transmission system for receiving data representative of the estimate from the controller and transmitting a direction signal to the device to be controlled, the direction signal being indicative of the intended direction. The direction signal is independent of rotation of the remote about the first axis.

Implementations include those in which the acceleration sensing system is configured to provide, to the controller, data indicative of acceleration at multiple locations within the remote. Among these are implementations in which the acceleration sensing system comprises accelerometers disposed at different locations within the remote. In one such implementation, the accelerometers disposed at different locations within the remote comprise a first accelerometer disposed at a first peripheral location within the remote, a second accelerometer disposed at a second peripheral location within the remote, and a third accelerometer disposed at a third peripheral location within the remote.

In other implementations, the controller is configured to estimate an intended direction of a gesture based at least in part on differences between the accelerations at multiple locations. Among these are implementations in which the controller is configured to identify a largest acceleration magnitude and to estimate an intended direction of a gesture based on the largest acceleration magnitude, and those in which the controller is configured to estimate an intended direction of a gesture by at least in part ignoring acceleration data from selected locations within the remote.

Yet other implementations include those in which the remote further comprises a housing having a first axis, the axisymmetric housing being rotationally symmetric about the first axis. These implementations include those in which the housing is hemispherical, those in which the housing has a circular cross-section, and those in which the housing comprises a surface having control actuators disposed thereon.

Among other implementations are those in which transmission system comprises infrared transmitters, and those in which the transmission system comprises a radio transmitter.

Implementations also include those in which the controller is configured to estimate the intended direction based only on acceleration that occurs during a prograde phase of the gesture, those in which the controller is configured to determine that acceleration data corresponds to a retrograde phase of the gesture and to ignore the data, those in which the controller is configured to detect a transition from a retrograde phase of the gesture to a prograde phase of the gesture based at least in part on a zero crossing of an acceleration profile, and those in which the controller is configured to detect a transition from a retrograde phase of the gesture to a prograde phase of the gesture based at least in part on an inflection point of an acceleration profile.

In another aspect, an apparatus includes a gesture-based remote. Such a remote includes means for detecting acceleration at multiple locations within the remote, and means for providing a signal having information concerning a direction of a gesture, the information being independent of orientation of the remote relative to a first axis.

In some implementations, the means for signaling is configured to estimate the direction at least in part by ignoring measurements of acceleration from the means for detecting acceleration.

Other examples also include those that further include a controlled device that receives the signal and performs a function in response to the signal.

These and other features will be apparent from the following detailed description and the accompanying figures, in which

### BRIEF DESCRIPTION OF THE FIGURES

FIG. 1 is an isometric view of an axisymmetric housing for a gesture-based controller;

FIG. 2 is an exploded view of the housing of FIG. 1, showing a circuit board;

FIG. 3 is a block diagram of the circuit board shown in FIG. 2;

FIGS. 4A and 4B show the placement of components on a circuit board as shown in FIG. 21

FIG. 5 illustrates acceleration vectors at each accelerometer; and

FIG. 6 illustrates the path followed by a typical gesture.

### DETAILED DESCRIPTION

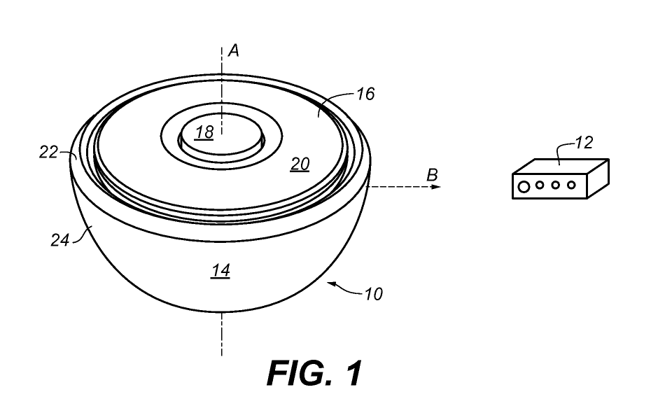

FIG. 1 shows a gesture-based remote 10 whose orientation is defined by a first axis A. The remote 10 translates a holder's gestures into instructions and transmits those instructions to a controlled device 12 in the direction indicated by a second axis B. Using such a remote 10, a holder can control various functions of the controlled device 12. For example, when the controlled device 12 is an audio component, the remote 10 can be programmed such that a gesture to the right causes a music player to move to the next track, while a gesture to the left causes the music player to move to the previous track.

An axisymmetric housing 14 encloses the remote 10. The housing 14 is shaped such that although one can discern the direction of the first axis A from the shape of the housing, there are no cues that would provide any clue concerning the direction of any other axis, such as the second axis B.

This axisymmetric housing 14 dispenses with the need to aim an active end of the remote at the controlled device 12. This eliminates the fumbling that often accompanies picking up a conventional remote in the dark, attempting to identify the transmitting end of the remote, and then aiming it at the component. The axisymmetric housing 14 also offers certain aesthetic advantages. The possibility of using such a housing opens up numerous design possibilities that were foreclosed by the need to communicate a preferred orientation to the holder.

In one implementation, shown in FIG. 1, the axisymmetric housing 14 is a hemisphere. However, other shapes are possible. For example, a puck-shaped housing would also have this property, as would an egg-shaped housing.

An advantage of the hemispherical housing 14 shown in FIG. 1 is the availability of a control surface 16 upon which can be placed various control buttons or interfaces. In the illustrated example, the control surface 16 has a central control button 18 and a rotatable annulus 20. The actual function of these controls is programmable. In one implementation, the rotatable annulus 20 functions as a volume control, and the control button 18 functions as a mute button. Although only mechanical controls are shown, it is also possible to provide the control surface 16 with capacitive touch-based controls, or a touch screen having a variety of programmable soft controls.

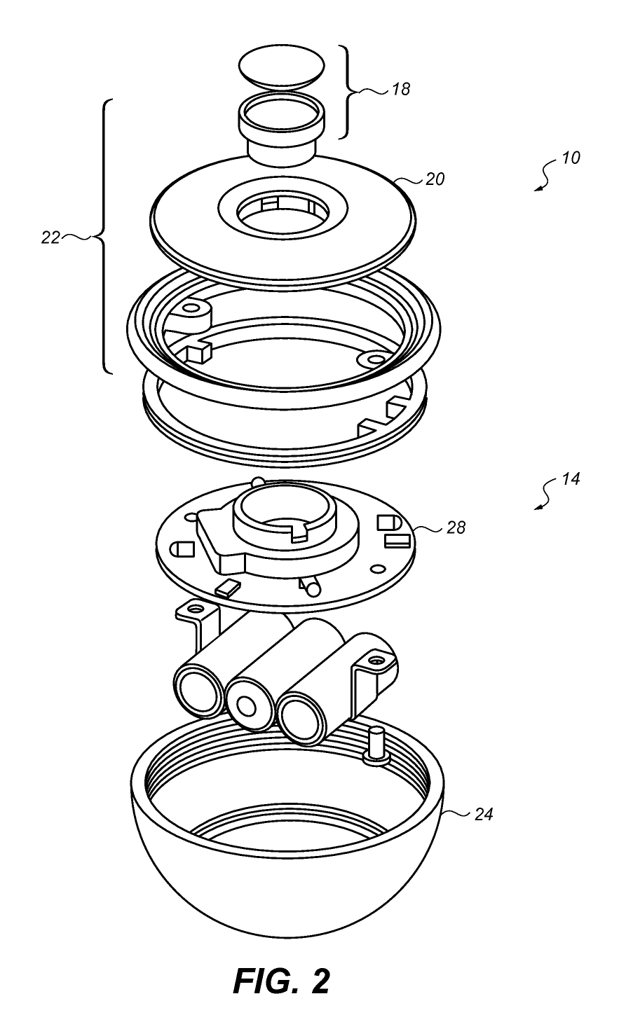

As shown in FIG. 2, the housing 14 comprises a cover 22 and a bowl 24 that are screwed together. In some implementations, the bowl 24 includes a circumferential lip that supports a circuit board 28. However, in other implementations, no lip is used, and the circuit board 28 is instead screwed to or suspended from the cover 22 or screwed into the bowl 24.

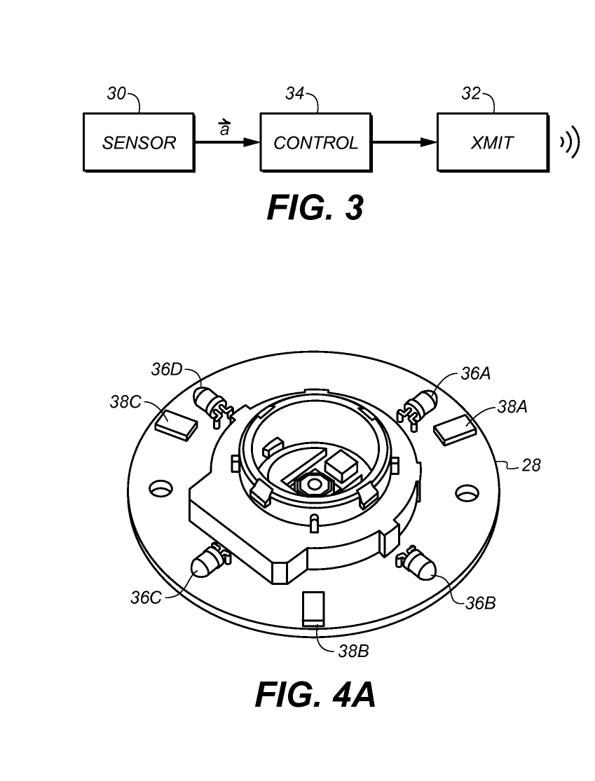

The overall architecture of the circuit board 28, as shown in FIG. 3, includes an acceleration-measurement subsystem 30, an instruction-transmitting subsystem 32, and a controller 34 that receives data from the acceleration-measurement subsystem 30, and, based on that data, determines what signals to transmit on the instruction-transmitting subsystem 32.

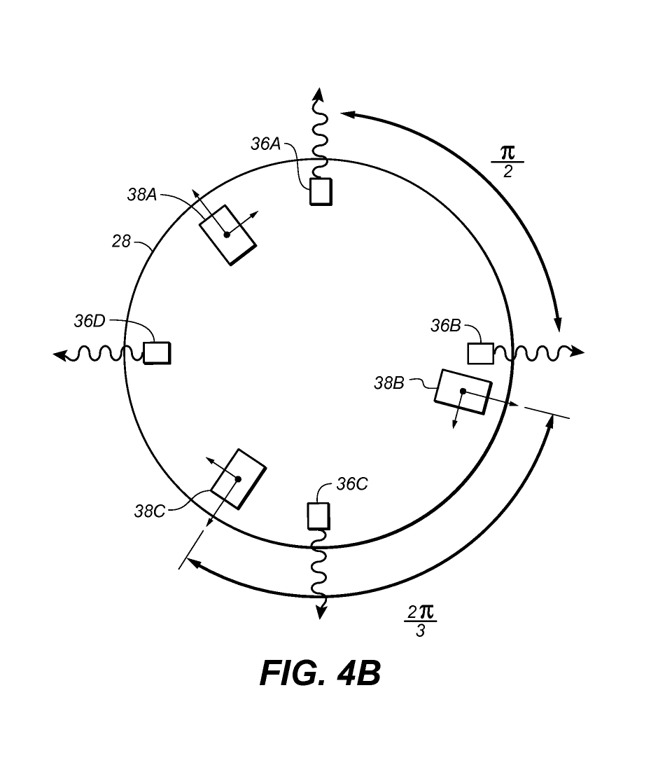

The instruction-transmitting subsystem 32 can take various forms. In one implementation, shown in isometric view in FIG. 4A and in plan view in FIG. 4B, the instruction-transmitting subsystem 32 includes plural infrared transmitters 36A-36D distributed around the periphery of the circuit board 28 at substantially equal angular intervals.

In operation, all the transmitters 36A-36D are activated at the same time. This ensures that no matter what portion of the controller's periphery faces the controlled device 12, there will be at least some infrared radiation directed towards the controlled device 12. Although the more transmitters there are, the more even the coverage will be, it has been found that, as a practical matter, four infrared transmitters spaced π/2 radians apart provide more than adequate coverage.

In other implementations, the instruction-transmitting subsystem 32 is an RF based system, such as a BLUETOOTH(R) system. These systems are advantageous because they are inherently omnidirectional.

In the implementation shown in FIGS. 4A and 4B, the acceleration-measurement subsystem 30 includes at least a first accelerometer 38A, a second accelerometer 38B, and a third accelerometer 38C disposed on the periphery of the circuit board 28. Preferably, the three accelerometers are located 2π/3 radians apart. Although the accelerometers 38A-38C need not be placed at the periphery, it will shortly be apparent that maximizing the radial distance between them will result in better performance.

Each accelerometer 38A-38C has a local coordinate system defined by orthogonal first, second, and third axes. These axes are oriented such that the third axis is the cross product of the first axis with the second axis. The accelerometers are oriented such that the third axes of all three local coordinate systems are parallel, the second axes are all oriented in the radial direction, and the first axes are all oriented in the tangential direction. For convenience, it will be useful to refer to the first axis of a local coordinate system as the “tangential axis” and the second axis of the local coordinate system as the “radial axis.”

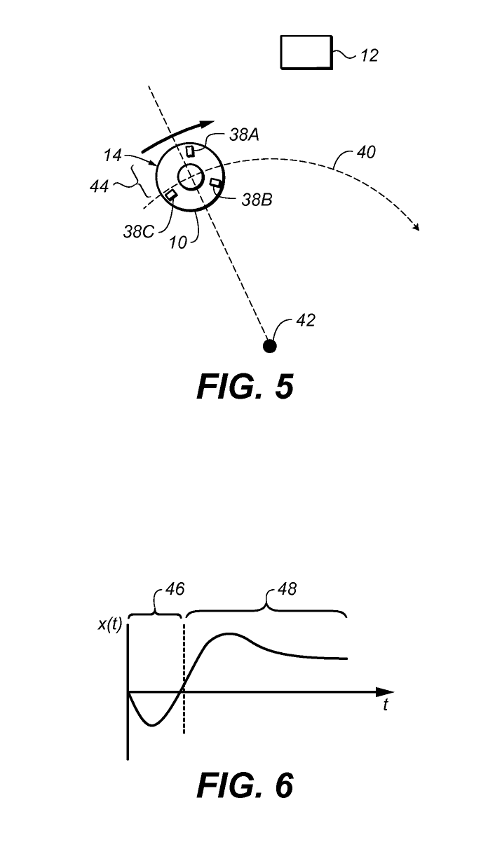

As shown in FIG. 5, when a holder gestures, the actual movement of the remote 10 is not along a straight line. Instead, the remote 10 pivots along an arc 40 about a pivot point 42. This pivoting motion arises naturally as a result of human anatomy.

Because a gesture moves the remote 10 along an arc 40 around a pivot point 42, a first accelerometer 38A furthest from the pivot point will experience greater linear acceleration than the other accelerometers 38B, 38C. This difference provides a basis for determining the orientation of the remote 10.

Although any number of accelerometers can be used, and although the accelerometers can be disposed anywhere on the circuit board 28 within the remote 10, it is preferable that there always be at least one accelerometer disposed on a distal half 44 of the housing 14. The placement of three accelerometers 38A-38C as shown in FIG. 4 is advantageous because this is the minimum number of accelerometers that will guarantee this property.

In response to a gesture, each accelerometer 38A-38C reports, to the controller 34, an acceleration along its local tangential axis and an acceleration along its local radial axis. For each accelerometer 38A-38C, the controller 34 calculates the magnitude of the acceleration vector for that accelerometer. The controller 34 then determines which of the three accelerometers provided the acceleration vector having the largest magnitude. r. This accelerometer will be designated as “the distal accelerometer” because it will be located on the distal half 44 of the circuit board 28. In the particular configuration shown in FIG. 5, the distal accelerometer would be the first accelerometer 38A.

Having determined which accelerometer is the distal accelerometer, the controller 34 can now ignore the measurements from the remaining accelerometers and use the sign of the tangential acceleration (i.e., the component of the acceleration vector that projects onto the tangential axis) of the distal accelerometer 38A to determine the direction of the gesture. The controller 34 then communicates this information to the controlled device 12 through the information-transmitting subsystem 32.

A difficulty that arises, however, is that a typical gesture resolves into a brief retrograde phase and a longer prograde phase, as shown in FIG. 6. The retrograde phase 46 is in the direction opposite to that of the intended gesture, and the prograde phase 48 is in the direction of the intended gesture.

It is apparent that if the controller 34 makes a decision on the direction of the gesture during the retrograde phase 46, it will arrive at the wrong result. Thus, to avoid this, it is preferable for the controller 34 to delay a decision until the retrograde phase 46 is over. On the other hand, the decision must not be delayed for too long. Otherwise, there will be a noticeable lag between the gesture and the response of the controlled device 12.

One solution is for the controller 34 to wait for a predetermined time before making a decision. However, the length of the retrograde phase 46 is not known in advance, since it depends on the holder's actions. To avoid this difficulty, a preferred controller 34 implements a retrograde-avoidance algorithm.

In one algorithm, the controller 34 exploits characteristics of the acceleration curve that corresponds to the displacement curve shown in FIG. 6. For example, the controller 34 can monitor the acceleration curve for the occurrence of features such as a zero-crossing or sign-change, for points of inflection, or for maxima and minima in an effort to determine when it is appropriate to make a decision concerning the intended direction of the gesture.

Having described the invention, and preferred implementations thereof, what we claim as new, and secured by Letters Patent is:

1. An apparatus comprising a gesture-based remote for controlling a controlled device, said gesture-based remote having a first axis that defines a transverse plane normal to said first axis, an acceleration sensing system configured to detect a direction of acceleration of said remote in said transverse plane, a controller, wherein said controller is configured to receive data from said acceleration sensing system and to, based at least in part on said data, estimate an intended direction of a gesture, and a transmission system for receiving data representative of said estimate from said controller and transmitting a direction signal to said device to be controlled, said direction signal being indicative of said intended direction, wherein said direction signal is independent of rotation of said remote about said first axis.

2. The apparatus of claim 1, wherein said acceleration sensing system is configured to provide, to said controller, data indicative of acceleration at multiple locations within said remote.

3. The apparatus of claim 1, wherein said controller is configured to estimate an intended direction of a gesture based at least in part on differences between said accelerations at multiple locations.

4. The apparatus of claim 3, wherein said controller is configured to identify a largest acceleration magnitude and to estimate an intended direction of a gesture based on said largest acceleration magnitude.

5. The apparatus of claim 3, wherein said controller is configured to estimate an intended direction of a gesture by at least in part ignoring acceleration data from selected locations within said remote.

6. The apparatus of claim 2, wherein said acceleration sensing system comprises accelerometers disposed at different locations within said remote.

7. The apparatus of claim 6, wherein said accelerometers disposed at different locations within said remote comprise a first accelerometer disposed at a first peripheral location within said remote, a second accelerometer disposed at a second peripheral location within said remote, and a third accelerometer disposed at a third peripheral location within said remote.

8. The apparatus of claim 1, wherein said remote further comprises a housing, said housing being rotationally symmetric about said first axis.

9. The apparatus of claim 8, wherein said housing is hemispherical.

10. The apparatus of claim 8, wherein said housing has a circular cross-section.

11. The apparatus of claim 8, wherein said housing comprises a surface having control actuators disposed thereon.

12. The apparatus of claim 1, wherein said transmission system comprises infrared transmitters.

13. The apparatus of claim 1, wherein said transmission system comprises a radio transmitter.

14. The apparatus of claim 1, wherein said controller is configured to estimate said intended direction based only on acceleration that occurs during a prograde phase of said gesture.

15. The apparatus of claim 1, wherein said controller is configured to determine that acceleration data corresponds to a retrograde phase of said gesture and to ignore said data.

16. The apparatus of claim 1, wherein said controller is configured to detect a transition from a retrograde phase of said gesture to a prograde phase of said gesture based at least in part on a zero crossing of an acceleration profile.

17. The apparatus of claim 1, wherein said controller is configured to detect a transition from a retrograde phase of said gesture to a prograde phase of said gesture based at least in part on an inflection point of an acceleration profile.

18. An apparatus comprising a gesture-based remote, said gesture-based remote comprising means for detecting acceleration at multiple locations within said remote, and means for providing a signal having information concerning a direction of a gesture, said information being independent of orientation of said remote relative to a first axis.

19. The apparatus of claim 18, wherein said means for signaling is configured to estimate said direction at least in part by ignoring measurements of acceleration from said means for detecting acceleration.

20. The apparatus of claim 18, further comprising a controlled device that receives said signal and performs a function in response to said signal.
